(19) United States
(12) Patent Application Publication
(10) Pub. No.: US 2025/0285540 A1
(43) Pub. Date: Sep. 11, 2025

(54) SYSTEMS AND METHODS FOR ESTIMATING PARKING SPOT AVAILABILITY

(71) Applicant: Valeo Schalter und Sensoren GmbH, Bietigheim-Bissingen (DE)

(72) Inventors: Thomas HEITZMANN, Bietigheim-Bissingen (DE); Xinhua XIAO, Bietigheim-Bissingen (DE); Deep DOSHI, San Mateo, CA (US); Lihao WANG, San Mateo, CA (US)

(21) Appl. No.: 18/600,944

(22) Filed: Mar. 11, 2024

(51) Int. Cl. G08G 1/14; G06V 20/58

(52) U.S. Cl. CPC G08G 1/143; G06V 20/586; G08G 1/146; G06V 2201/08

(57) ABSTRACT

Methods and systems for assisting drivers in finding available parking spots by estimating parking spot availabilities. Vehicle image sensors, and associated image processing techniques, detect whether or not other vehicles are located in parking spaces. An occupancy status of each parking spot is determined over time based on these image processing results, and the occupancy status is stored, for example as historical data. The occupancy statuses can be stored or retrieved based on a particular geographical region. An estimated occupancy status of a first parking spot can be generated based upon a last-known occupancy status of that parking spot and the average parking spot availabilities of nearby parking spots in that geographic region. The estimated occupancy status can be displayed, for example as overlaid into a map or navigation application.

### TECHNICAL FIELD

The present disclosure relates to systems and methods for estimating parking spot availability.

### BACKGROUND

Modern automotive vehicles are typically equipped with a variety of sensors. Whether internal or external to the passenger cabin of the vehicle, these sensors provide the foundation for driving automation and vehicle autonomy. Vehicles with autonomous or semi-autonomous driving or driver-assistant features use these sensors and associated computer vision technology to provide parking assistance. Parking assist systems can not only help drivers find available parking spots, but also help drivers park their vehicles in parking spaces, either automatically or guiding the driver to do so.

Vehicle drivers can rely on a plurality of services to help find available parking spots. For example, some dedicated parking apps focus specifically on providing information about parking lots and garages, such as pricing, hours of operation, and user reviews. Some cities have implemented smart parking meters that can provide real-time information about whether a particular parking spot's meter has not been paid and is thus likely available to park in. In more advanced systems, high definition (HD) maps and community-based information along with real-time sensor data can be utilized to update a status of a parking space, particularly in dense urban areas.

### SUMMARY

In an embodiment, a system for estimating parking spot availability includes a plurality of image sensors mounted to a plurality of vehicles and configured to generate images associated with an environment about the plurality of vehicles. The system includes one or more processors in communication with the plurality of image sensors. The one or more processors are programmed to: execute image processing to determine a presence of parking spots in the images and whether other vehicles are located in the parking spots; determine an occupancy status of each parking spot over time based upon the image processing; store the occupancy status of each parking spot in storage to yield a historical occupancy status; define a first set of the parking spots as being located within a first common geographical region; determine an average parking spot availability of the first set of parking spots based on the historical occupancy status associated with the first set of parking spots; generate an estimated occupancy status of a first parking spot of the first set of parking spots, wherein the estimated occupancy status is based on a last-known occupancy status of the first parking spot and the average parking spot availability associated with the first set of parking spots; and display the estimated occupancy status of the first parking spot on a display device associated with a first vehicle of the plurality of vehicles.

In another embodiment, a method of assisting a driver in finding an available parking spot by estimating parking spot availability includes: generating, via a plurality of image sensors mounted to a plurality of vehicles, images associated with an environment surrounding the plurality of vehicles; executing image processing to determine a presence of parking spots in the images and whether other vehicles are located in the parking spots; determining an occupancy status of each parking spot over time based upon the image processing; storing the occupancy status of each parking spot in storage to yield a historical occupancy status associated with the parking spots; defining a first set of the parking spots as being located within a first common geographical region; determining an average parking spot availability of the first set of parking spots based on the historical occupancy status associated with the first set of parking spots; generating an estimated occupancy status of a first parking spot of the first set of parking spots based upon the average parking spot availability associated with the first set of parking spots; and displaying the estimated occupancy status of the first parking spot on a display device associated with a first vehicle of the plurality of vehicles.

In other embodiments, non-transitory data storage medium can include programming instructions that, when executed by a processor, cause the processor to perform the steps above.

### BRIEF DESCRIPTION OF THE DRAWINGS

FIG. 1 illustrates a block diagram depicting an example system of estimating an availability of a parking spot, according to an embodiment.

FIGS. 2A-2B are sequential overhead views of a vehicle traveling near a parking zone and collecting data regarding the occupancy of parking spaces, according to an embodiment.

FIG. 3 is a process flow diagram illustrating execution of a system for estimating parking spot availability, according to an embodiment.

FIG. 4 is a schematic illustration of a determination of average parking occupancies over time for a given zone or region, according to an embodiment.

FIG. 5 is an example of a user interface on a display device indicating estimated available parking spaces, according to an embodiment.

FIG. 6 illustrates a method for assisting a driver in finding an available parking space by estimating the occupancy of parking spaces, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Some portions of this description describe the embodiments of the disclosure in terms of algorithms and operations. These operations are understood to be implemented by computer programs or equivalent electrical circuits, machine code, or the like, examples of which are disclosed herein. Furthermore, these arrangements of operations may be referred to as modules or units, without loss of generality. The described operations and their associated modules or units may be embodied in software, firmware, and/or hardware.

Steps, operations, or processes described may be performed or implemented with one or more hardware or software modules, alone or in combination with other devices. Although the steps, operations, or processes are described in sequence, it will be understood that in some embodiments the sequence order may differ from that which has been described, for example with certain steps, operations, or processes being omitted or performed in parallel or concurrently.

References herein to a “parking zone” should be construed to include parking lots, parking garages, streets with parking spots (e.g., parallel or angled parking spots next to a drive lane on a road), and other similar spaces where several parking spots are concentrated or grouped together. A parking zone can include a physical area that is established for parking, storing, or keeping a vehicle for a period of time. The parking zone can include one or more markers, lines, signs, or other indications to facilitate parking or define aspects of the parking zone. For example, the parking zone may include parking lines that define or allocate a physical area or space in which a vehicle is to park. The terms parking space and parking spot can be used interchangeably herein. The parking lot can include signs that provide parking restrictions, such as types of vehicles that can park in a parking space or spot (e.g., small vehicle, mid-size vehicle, full size vehicle, sports utility vehicle, truck, hybrid, electric vehicle), requirements (e.g., handicap sticker), or time constraints (e.g., 1 hour parking, 2 hour parking).

It is nearly ubiquitous for modern vehicles to be equipped with a variety of sensors. Whether internal or external to the passenger cabin of the vehicle, these sensors provide the foundation for driving automation and vehicle autonomy. Vehicles with autonomous or semi-autonomous driving or driver-assistant features can use these sensors and associated computer vision technology to provide parking assistance. Parking assist systems can help drivers park their vehicles in parking spaces, either automatically or guiding the driver to do so. For example, in some advanced systems, high definition (HD) maps and community-based information along with real-time sensor data can be utilized to update a status of a parking space, particularly in dense urban areas. In some of these systems, vehicles that pass by a particular parking spot (or enter or exit the parking spot) can utilize on-board sensors to determine whether that parking spot is occupied or unoccupied. This information can be wirelessly transmitted through a communication network, whereupon other vehicles can be informed as to the availability or unavailability of that parking spot.

However, these sort of systems may not provide accurate real-time data as to the occupancy of a particular parking spot. For example, some vehicles may not be equipped with the proper sensory equipment or may not be subscribed to the proper services that would allow for those vehicles to transmit parking spot availability data to other vehicles. Such a parking spot availability system might only function properly if a certain threshold number of vehicles on the roads are properly equipped or subscribed.

Therefore, according to various embodiments, this disclosure provides methods and systems for estimating parking spot availability even when live, real-time availability data may be lacking. The methods and systems are configured to estimate whether a parking spot is available or unoccupied based upon the execution of a parking spot classification model, which relies upon historical occupancy status of the particular parking spot. The historical occupancy status can be derived from vehicle sensor data, while vehicles with image sensors travel past or near that particular parking spot. Based on this historical data, the parking spot classification model can estimate whether that particular parking spot is available for parking, even when real-time data of its occupancy may not be available.

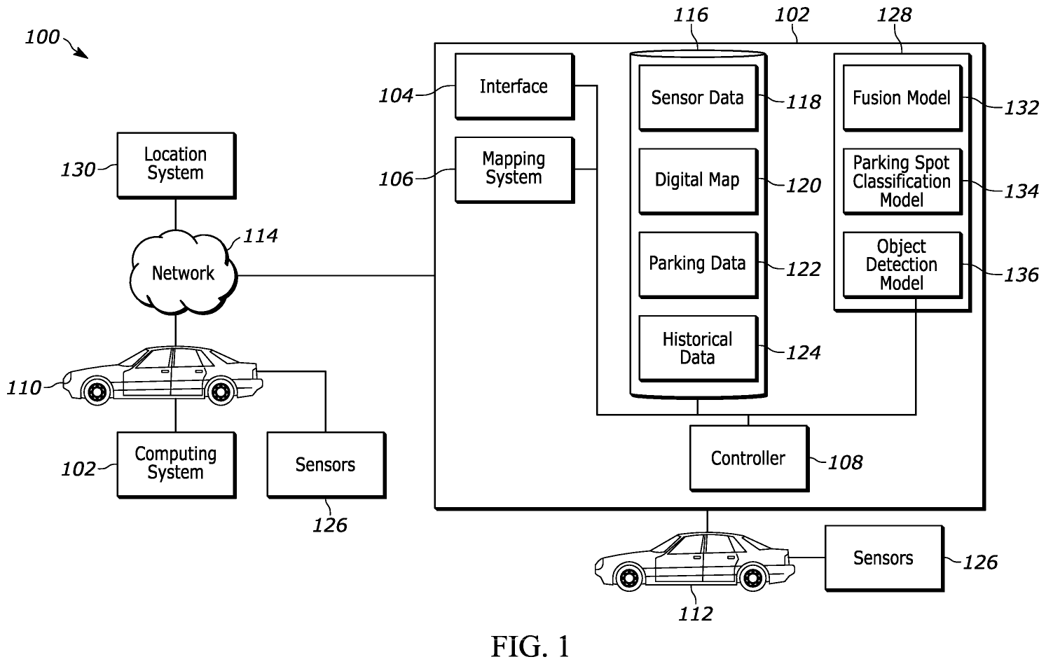

FIG. 1 illustrates a block diagram depicting an example system 100 for assisting a vehicle or its driver to find an available parking spot, according to an embodiment. The system 100 can include at least one computing system 102 for use in processing sensor data, executing machine learning models, map generation and updating based on the sensor data, and storing data for example. The computing system can include at least one interface 104, and at least one mapping system 106 for generating and updating a digital map of a parking zone, and at least one controller 108. The computing system 102 (e.g., controller 108) can include hardware or a combination of hardware and software, such as communications buses, circuitry, processors, communications interfaces, among others. The computing system 102 can reside on or within a corresponding vehicle (e.g., a host vehicle). For example, FIG. 1 shows a first vehicle 110 with a computing system 102 on-board, and a second vehicle 112 with another or similar computing system 102 on-board. Alternatively (or in addition), all or part of the computing system 102 can reside on a remote server (e.g., the cloud) which is communicatively coupled to the vehicles 110, 112 via a network 114. Each of the first vehicle 110 and the second vehicle 112 (or their corresponding computing system 102) can be communicatively connected to the network 114 to each other (e.g., via vehicle-to-vehicle (V2V) communication), to the cloud (e.g., via vehicle-to-cloud (V2C) communication), and/or to one or more other systems (e.g., a global positioning system (GPS), or to one or more communications devices). For example, the vehicles may include one or more transceivers configured to establish a secure communication channel with another vehicle or the remote server wirelessly using one or more communication protocols, such as, for example, communication protocol based on vehicle-to-vehicle (V2V) communications, wireless local area network (WLAN) or wireless fidelity (WiFi, e.g., any variant of IEEE 802.11 including 802.11a/b/g/n), wireless personal area network (WPAN, e.g., Bluetooth, Zigbee), cellular (e.g., LTE, 3G/4G/5G, etc.), wireless metropolitan area network WIMAN (e.g., WiMax), and other wide area network, WAN technologies (e.g., iBurst, Flash-OFDM, EV-DO, HSPA, RTT, EDGE, GPRS), dedicated short range communications (DSRC), near field communication (NFC), and the like. This enables the exchange of information and data that is described herein.

The computing system 102 can also include at least one data repository or storage 116. The data repository 116 can include or store sensor data 118 (originating from the sensors described herein), a digital map or digital map data 120, parking data 122, and historical data 124. The sensor data 118 can include information about available sensors, identifying information for the sensors, address information, internet protocol information, unique identifiers, data format, protocol used to communicate with the sensors, or a mapping of information type to sensor type or identifier. The sensor data 118 can further include or store information collected by vehicle sensors 126. The sensor data 118 can include or store sensor data using timestamps and date stamps. The sensor data 118 can include or store sensor data using location stamps. The sensor data 118 can categorize the sensor data based on a parking spot or characteristics of a parking spot.

Vehicle sensors 126 that generate the sensor data 118 can include one or more sensing elements or transducers that captures, acquires, records or converts information about its host vehicle or the host vehicle's environment into a form for processing. The sensor 126 can acquire or detect information about parking zones. The sensors 126 can detect a parking zone condition such as a road feature, boundary, intersection, lane, lane marker, or other condition. The sensors 126 can also detect the occupancy of a parking zone or a particular parking spot, for example by detecting the boundaries of a parking spot and whether an object (e.g., another vehicle) is located within the boundaries. In embodiments, the sensors 126 can detect the relative position between another vehicle and a parking spot, e.g., whether or not a parking spot is occupied by a vehicle as indicated by at least a portion of the vehicle being between the boundaries of two adjacent parking spot lines. The sensors 126 can also detect a feature of a particular parking space, such as symbols that represent the parking space is for handicapped, emergency vehicles only, pregnant women (expectant mothers), and the like. The sensors 126 can, for example, acquire one or more images of the parking zone or parking spot, which can be processed using image processing and object recognition to identify or detect features indicative of a parking zone, e.g., a parking sign, a stop sign, a handicap parking sign, or surface markings on a parking zone. As examples, the sensor 126 can be or include an image sensor such as a photographic sensor (e.g., camera), radar sensor, ultrasonic sensor, millimeter wave sensor, infra-red sensor, ultra-violet sensor, light detection sensor, lidar sensor, or the like. The sensor 126 can communicate sensed data, images or recording to the computing system 102 for processing, which can include filtering, noise reduction, image enhancement, etc., followed by object recognition, feature detection, segmentation processes, and the like. The raw data originating from the sensors 126 as well as the processed data by the computing system 102 can be referred to as sensor data 118 or image data that is sensed by an associated sensor 126.

The sensor 126 can also include a global positioning system (GPS) device that can determine a location of the host vehicle relative to an intersection, using map data with an indication of the parking zone. The GPS device can communicate with location system 130, described further below. The computing system 102 can use the GPS device and the map data to determine that the host vehicle (e.g., first vehicle 110) has reached the parking zone, along with the relative distance and/or location to a particular parking spot. The computing system 102 can use the GPS device and the map data to determine the boundaries of the parking zone or one or more parking spots nearby the vehicle. The sensor 126 can also detect (e.g., using motion sensing, imaging or any of the other sensing capabilities described herein) whether any other vehicle or object is present at or approaching the parking zone, and can track any such vehicle or object's position or movement over time for instance. For example, based on the sensed data, the computing system 102 can determine a current location of another vehicle relative to a parking spot, and project a future location of the vehicle based on projection models.

Using any one or more of the aforementioned types of sensors 126, the vehicle (e.g., first vehicle 110) is able to virtually map the parking zone. For example, the sensors calculate relatives distances between detected objects and the sensor itself, and the computing system 102 can utilize mapping system such as a visual simultaneous localization and mapping (SLAM) system. Visual SLAM is a position detecting scheme in which a process of generating a digital map of an environment (such as a parking zone) and a process of acquiring a location of the sensor or vehicle itself are complementarily performed. In other words, characteristics of the environment about the vehicle as well as the location of the vehicle itself are determined simultaneously.

The mapping system 106 can implement visual SLAM (or similar technologies) to generate a digital map of the parking zone. The mapping system 106 is designed, constructed or operational to generate digital map data based on the data sensed by the one or more sensors 126. The digital map data structure (or referred to as digital map 120) can generate the digital map from, with or using one or more machine learning models or neural networks established, maintained, tuned, or otherwise provided via one or more machine learning models 128. The machine learning models 128 can be configured, stored, or established on the computing system 102 of the first vehicle 110, or on a remote server. The mapping system 106 can detect, from a first neural network and based on the data sensed by the one or more sensors 126, objects located at the parking lot. The mapping system 106 can perform, using the first neural network and based on the data sensed by the one or more sensors 126, scene segmentation. The mapping system 106 can determine, using the first neural network and based on the data sensed by the one or more sensors 126, depth information for the parking zone. The mapping system 106 can identify, from the first neural network 114 and based on the data sensed by the one or more sensors 126, one or more parking lines or parking spots in the parking zone, and whether another vehicle or other object is located in the parking spot, indicating the parking spot is unavailable for parking or occupied. The mapping system 106 can construct the digital map based on the detected objects located at the parking zone, the scene segmentation, the depth information for the parking zone, and the one or more parking lines at the parking zone.

The mapping system 106 can create the digital map 120 based on the sensor data 118. This digital map 120 can be created in many different embodiments. In one embodiment, the digital map 120 is created via implemented visual SLAM, as described above. In one embodiment, the digital map 120 can include three dimensions on an x-y-z coordinate plate, and associated dimensions can include latitude, longitude, and range, for example. In other embodiments, the digital map 120 is created via systems that require less processing capabilities than SLAM, such as object recognition fused with a pre-stored map of the parking zone, thus allowing the system to simply update the status of a parking spot as either occupied or unoccupied based on the image data currently detected. The digital map 120 can be updated periodically or reflect or indicate a motion, movement or change in one or more objects detected in the parking zone. For example, the digital map can be updated to alter the state of a known parking space as either occupied or unoccupied based upon whether the current sensor data indicates another object being within the boundaries of that parking space.

Various types of machine learning models 128 are disclosed herein. The machine learning model utilized by the mapping system 106 to generate the digital map 120, along with the occupancy status of a particular parking spot, can include any type of neural network, including, for example, a convolution neural network, deep convolution network, a feed forward neural network, a deep feed forward neural network, a radial basis function neural network, a Kohonen self-organizing neural network, a recurrent neural network, a modular neural network, a long/short term memory neural network, or the like. Each machine learning model 128 can maintain, manage, store, update, tune, or configure one or more neural networks and can use different parameters, weights, training sets, or configurations for each of the neural networks to allow the neural networks to efficiently and accurately process a type of input and generate a type of output.

One or more of the disclosed machine learning models 128 disclosed herein can be configured as or include a convolution neural network. The convolution neural network (CNN) can include one or more convolution cells (or pooling layers) and kernels, that can each serve a different purpose. The convolution kernel can process input data, and the pooling layers can simplify the data, using, for example, non-linear functions such as a max, thereby reducing unnecessary features. The CNN can facilitate image recognition. For example, the sensed input data can be passed to convolution layers that form a funnel, compressing detected features. The first layer can detect first characteristics, the second layer can detect second characteristics, and so on.

The convolution neural network can be a type of deep, feed-forward artificial neural network configured to analyze visual imagery. The convolution neural network can include multilayer perceptrons designed to use minimal preprocessing. The convolution neural network can include or be referred to as shift invariant or space invariant artificial neural networks, based on their shared-weights architecture and translation invariance characteristics. Since convolution neural networks can use relatively less pre-processing compared to other image classification algorithms, the convolution neural network can automatically learn the filters that may be hand-engineered for other image classification algorithms, thereby improving the efficiency associated with configuring, establishing or setting up the neural network, thereby providing a technical advantage relative to other image classification techniques.

One or more of the machine learning models 128 disclosed herein can include a CNN having an input layer and an output layer, and one or more hidden layers that can include convolution layers, pooling layers, fully connected layers, or normalization layers. The one or more pooling layers can include local pooling layers or global pooling layers. The pooling layers can combine the outputs of neuron clusters at one layer into a single neuron in the next layer. For example, max pooling can use the maximum value from each of a cluster of neurons at the prior layer. Another example is average pooling, which can use the average value from each of a cluster of neurons at the prior layer. The fully connected layers can connect every neuron in one layer to every neuron in another layer.

To assist in generating the digital map 120 including a determination of whether a particular parking space is occupied, the computing system 102 can interface or communicate with a location system 130 via network 114. The location system 130 can determine and communicate the location of one or more of the vehicles 110, 112 during the performance of the SLAM or similar mapping techniques executed in generating the digital map 120. The location system 130 can include any device based on a positioning system such as Global Navigation Satellite System (GNSS), which can include GPS, GLONASS, Galileo, Beidou and/or other regional systems. The location system 130 can include one or more cellular towers to provide triangulation. The location system 130 can include wireless beacons, such as near field communication beacons, short-range wireless beacons (e.g., Bluetooth beacons), or Wi-Fi modules.

The computing system 102 can be configured to utilize interface 104 to receive and transmit information. The interface 104 can receive and transmit information using one or more protocols, such as a network protocol. The interface 104 can include a hardware interface, software interface, wired interface, or wireless interface. The interface 104 can facilitate translating or formatting data from one format to another format. For example, the interface 104 can include an application programming interface that includes definitions for communicating between various components, such as software components. The interface 104 can be designed, constructed or operational to communicate with one or more sensors 126 to collect or receive information, e.g., image data. The interface 104 can be designed, constructed or operational to communicate with the controller 108 to provide commands or instructions to control a vehicle, such as the first vehicle 110. The information collected from the one or more sensors can be stored as shown by sensor data 118.

The interface 104 can receive the image data sensed by the one or more sensors 126 regarding an environment or characteristics of a parking zone. The sensed data received from the sensors 126 can include data detected, obtained, sensed, collected, or otherwise identified by the sensors 126. As explained above, the sensors 126 can be one or more various types of sensors, and therefore the data received by the interface 104 for processing can be data from a camera, data from an infrared camera, lidar data, laser-based sensor data, radar data, transducer data, or ultrasonic sensor data. Because this data can, when processed, enable information about the parking zone to be visualized, this data can be referred to as image data.

The data sensed from the sensors 126 can be received by interface 104 and delivered to mapping system 106 for detecting various qualities or characteristics of a parking zone (e.g., parking lines, handicapped spaces, etc.) as explained above utilizing techniques such as segmentation, CNNs, or other machine learning models. For example, the mapping system 106 can rely on one or more neural networks or machine learning models 128 to detect objects, scene segmentation, roads, terrain, trees, curbs, obstacles, depth or range of the parking lot, parking line detection, parking marker detection, parking signs, or other objects at or associated with the parking zone. The computing system 102 can train the machine learning models 128 using historical data 124. This training can be performed remote from a computing system 102 installed on a vehicle 110, 112. In other words, the computing system 102 may be on a remote server for at least these purposes. Once trained, the models can be communicated to or loaded onto the vehicles 110, 112 via network 114 for execution.

The historical data 124 can also include the past occupancy status of a parking zone or parking space. For example, the times that a particular parking spot is occupied can be sensed by one or more of the passing-by vehicles 110, 112, by leveraging the image and the associated timestamp of that data. As will be discussed more below, this historical data 124 can be used to estimate a parking spot occupancy status even when live data of that parking spot is not available. The most recent of the historical data can be used to update the digital map 120, particularly the occupancy status of a parking space.

Once generated, the digital map 120 can be stored in storage 116 and accessed by other vehicles. For example, the computing system 102 of a first vehicle 110 may be utilized to at least in part generate the digital map 120, whereupon that digital map 120 can be accessed by the computing system 102 of a second vehicle 112 that subsequently enters the parking zone. The computing system 102 of the second vehicle 112 (and other vehicles) can be utilized to update the digital map 120 in real-time based upon more reliable data captured form the second vehicle 112. In addition, the computing system 102 of both vehicles 110, 112 can be used to generate and continuously update parking data 122 in real-time. The parking data 122 represents data indicating characteristics of particular parking spots. For example, the parking data 122 can include a location of one or more parking spots, whether or not those parking spots are occupied or not occupied by a vehicle, and whether one or more of the parking spots are reserved for handicapped individuals, emergency vehicles only, vehicles carrying pregnant mothers, and the like, as described above. These qualities of the individual parking spots can be determined via the image data received from sensors 126 either when the digital map is generated, and/or when the digital map is updated by a second vehicle 112 or other vehicles.

As described above, one or more machine learning models 128 can be relied upon to perform the various functions described herein. These machine learning models 128 can include a fusion model 132, a parking spot classification model 134, an object detection model 136, and other models. The fusion model 132 is trained and configured to receive and fuse the image data 118, the digital map 120, and the parking data 122 and perform the object detection and classification described herein, the results of which can be input into the parking spot classification model 134, for example.

The objection detection model 136 is trained and configured to, based on the above data, detect objects or obstacles in the parking zone. This can include parking lines used to determine whether a parking spot is present. The objection detection model 136 can, for example, determine the presence of a vehicle in a parking spot, thus enabling the parking spot classification model 134 to determine that the parking spot is occupied. The objection detection model 136 can also determine the presence of a pothole, cone, debris, or other object in the parking zone, which can be stored in storage 116 and communicated to other vehicles (e.g., vehicle 112) that subsequently enter the parking zone.

The parking spot classification model 134 is trained and configured to, based on the above data, determine whether or not particular parking spots in a parking zone are occupied by other vehicles (and thus unavailable for parking), or not occupied by other vehicles (and thus available for parking). The parking spot classification model 134 can classify each parking spot as being available or unavailable based on current sensor data. For example, the parking spot classification model 134 can be a machine learning model that determines whether each parking spot is occupied or unoccupied, based upon a detected object (e.g., another vehicle) being sensed as located within that parking spot, which can be output by the object detection model 136. Alternatively, or in addition, the parking spot classification model 134 can estimate the classification of a particular parking spot based upon historical data 124 indicating the historical occupancy status of that parking spot, as described further herein. In some embodiments, the parking spot classification model 134 does not rely on neural networks, i.e., is not a machine learning model but instead relies on algorithms disclosed herein.

In some embodiments, the parking spot classification model 134 can also determine whether each parking spot is a normal parking spot, a handicapped parking spot, a charging station for an electric vehicle (and, for example, whether that charging station is for wireless charging or charging by cable), and/or whether each parking spot has an allowed duration of parking (e.g., 1 hour, 2 hours, etc.). The output of this parking spot classification model 134 can be used to update the digital map 120 and parking data 122 if necessary.

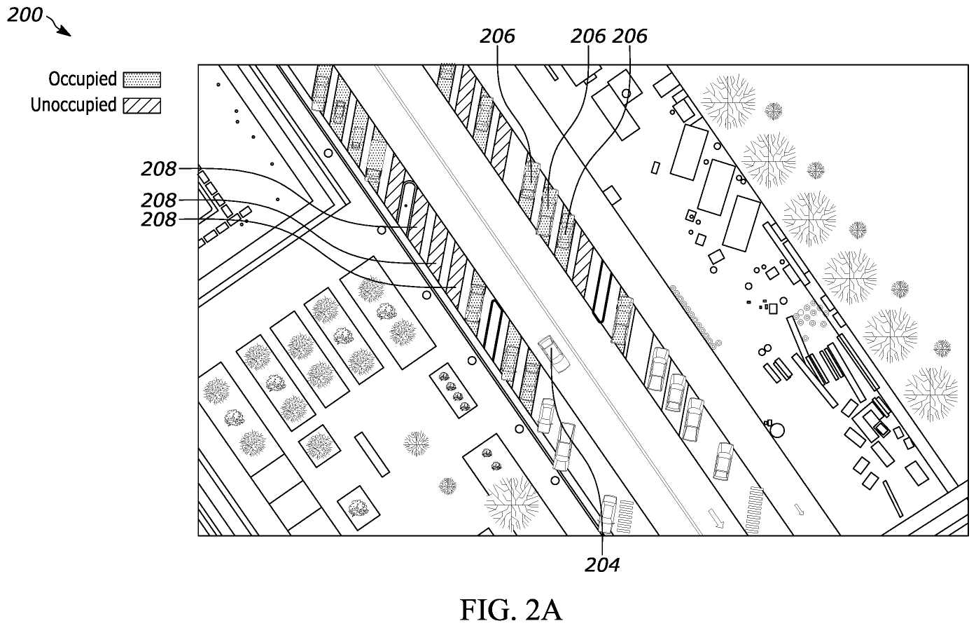

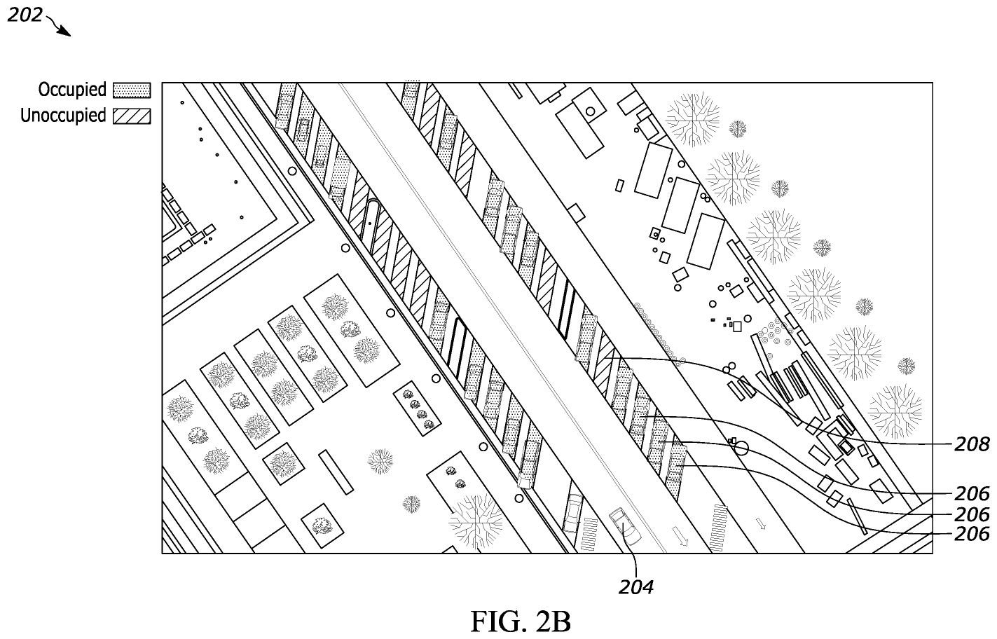

FIGS. 2A-2B show sequential overhead views 200, 202 of a vehicle assisting in classifying the parking spots as either occupied or unoccupied. Here, an ego vehicle 204 is shown traveling down a roadway. The vehicle 204 may be a vehicle 110, 112 equipped with the associated computing system 102 and sensors 126, for example. The vehicle 204 is shown traveling down a roadway that has a plurality of angled parking spots on either side of the road. This is one example of a type of parking zone.

In the first sequential overhead view 200, the vehicle 204 has traveled by some of the parked vehicles in the parking spots. During this time, the vehicles sensors 126 (e.g., cameras) have detected the presence of parking spots. Alternatively, the vehicle 204 has received map information of the parking zone, wherein the map information indicates the presence of parking spots nearby based upon the determined location of the vehicle 204 (e.g., via GPS). The vehicle sensors 126 also detect whether a vehicle is located in the particular parking spots when those parking spots are in the field of view of the vehicle sensors 126. This allows the system 100 to classify each parking spot as either occupied or unoccupied, based upon whether other vehicles are detected by the vehicle sensors 126 with the parking spaces. The system can classify or characterize each parking spot accordingly. In the example shown in FIG. 2A, occupied parking spots 206 are designated or marked with a first marker (e.g., shaded red), while unoccupied parking spots 208 are designated or marked with a second marker (e.g., shaded green).

The occupancy status of each parking spot (e.g., occupied parking spots 206 and/or unoccupied parking spots 208) can be transmitted via network 114 to a computing system 102 of a remote server, whereupon it is saved in storage 116, for example as parking data 122 and/or historical data 124 which can later be relied upon by the parking spot classification model 134 in estimating whether a parking space is occupied or unoccupied when live parking data of that parking space is unavailable. This is further described below.

In the second sequential overhead view 202, the vehicle 204 has traveled further down the roadway, thereby enabling the vehicle sensors 126 to detect the occupancy of additional parking spots. This allows the system 100 to properly classify the occupancy status of more parking spaces in the parking zone. In other words, additional parking spots are classified as occupied parking spots 206 and unoccupied parking spots 208 as the vehicle 204 travels along the roadway or parking zone. Once again, the identification of vehicles in parking spaces, or the classification of the parking spaces themselves, can be transmitted via network 114 to a computing system 102 (such as residing on a remote server), whereupon that data can be saved as parking data 122 and/or historical data 124.

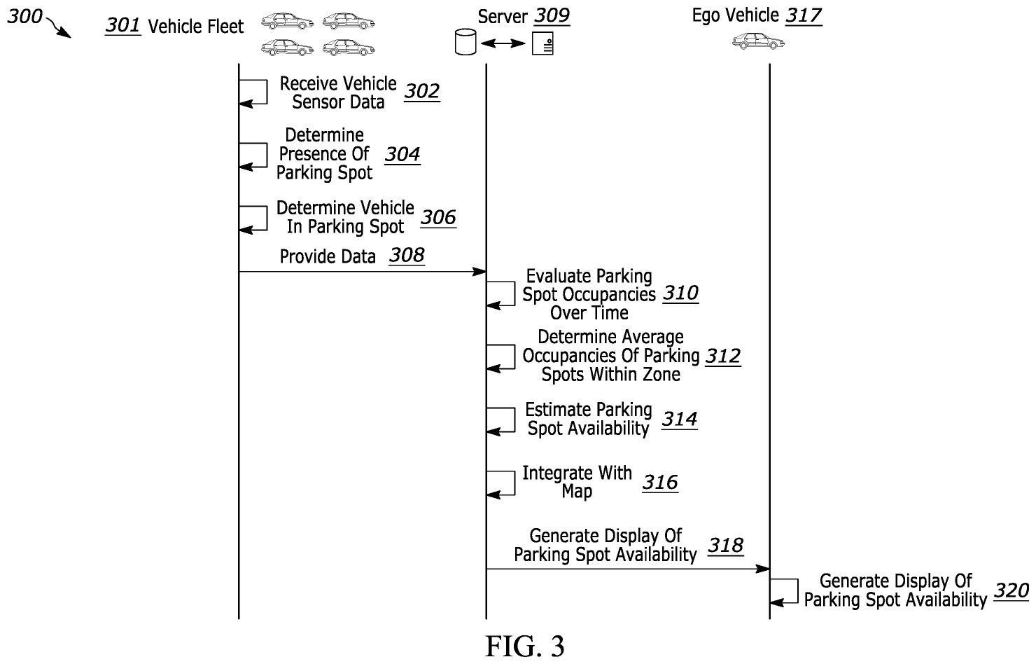

FIG. 3 is a process flow diagram 300 illustrating execution of a system for estimating parking spot availability, according to an embodiment. This illustrated process can be embodied and executed by the system 100 for estimating parking spot availability, shown generally in FIG. 1. The structure described with respect to FIG. 1 can be used to execute this process. For example, each vehicle and the server can include a respective computing system 102 for execution of the operations disclosed herein.

First, a fleet of vehicles 301 are provided. Each vehicle in the fleet may be vehicle 110, 112 from FIG. 1. Each vehicle in the fleet may be subscribed for a common service, such as an application that would allow the driver of that vehicle to find available parking spaces based on the system's estimation. Generally, each vehicle in the fleet should have at least one sensor 126 capable of determining the presence of objects about the vehicle. At 302, this can be stored as vehicle sensor data 118 at the vehicle.

Likewise, at 304, one or more of the vehicles in the fleet 301 determines the presence of a parking space. This can be performed using the vehicle's computing system 102, as explained above. This can include image processing to identify parking lanes lines, parking boundaries, and the like. This can also rely upon provided map data (e.g., HD Map), either stored locally at the vehicle or provided from a remote server or from other vehicles.

At 306, one or more of the vehicles in the fleet 301 determines whether or not a vehicle is located within the identified parking spaces. Again, this can be performed using the vehicle's computing system 102, as explained above. This can include image processing (e.g., object recognition) to identify vehicles (e.g., cars, trucks, motorcycles, etc.) being located within the identified boundaries of the parking spaces. Locally, at the vehicle, the computing system 102 can classify each detected parking space as either occupied or unoccupied based upon whether or not a vehicle is in the parking space. Alternatively, at least some of the data resulting from the image processing is transferred to a remote server whereupon the server's computing system 102 can perform this classification.

In embodiments, at 308 at least some of the data generated at the vehicle is transferred to a remote server 309. The remote server 309 has a computing system 102 described above, e.g., processor, memory, storage, and ability to execute models 128. The data provided at 308 can include the sensor data, data representing the presence of parking spots, and/or data representing a vehicles being parked in the parking spots. If the vehicle's onboard computing system 102 also performs classification of parking spots, then the classification data can be sent at 308 as well. Once received at the server 309, this data can be stored in the storage 116 at the server, e.g., in the form of sensor data 118, parking data 122, historical data 124, and the like. The data can be received by a plurality of vehicles in the fleet 301, and therefore the server 309 can aggregate the data.

At 310, the server 309 evaluates parking spot occupancies over time. This is based on the aggregated data received from the plurality of vehicles. As explained above, the computing system 102 of either the vehicle 110, 112 or the server 309 can perform the image processing to determine whether a particular parking spot is occupied or not. Regardless, the server 309 can store the parking spot occupancy status of each individual parking spot of one or more parking zones, e.g., in the form of historical data. The parking spot occupancy status can be stored with a timestamp so that the server can store whether the parking spot was occupied or unoccupied, and at what times (based on when the raw data was captured by the vehicle sensors 126).

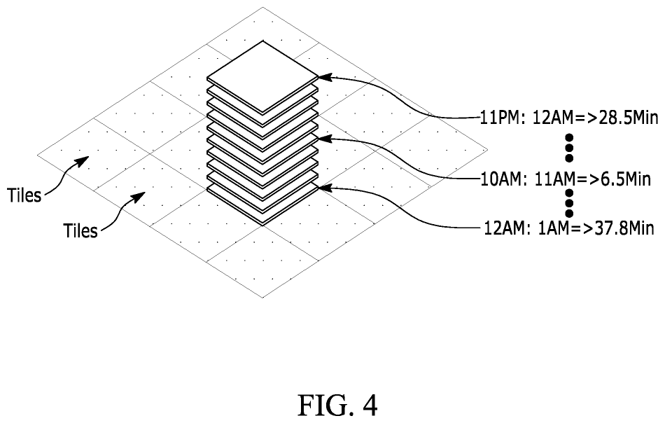

At 312, the server 309 determines the average occupancy (or, alternatively, average availability) of parking spaces within a particular zone over time. FIG. 4 provides an example of this concept. Shown in FIG. 4 are a plurality of tiles. Each tile represents a spatial boundary of earth, or a spatial zone, or geographical region. This can be, for example, a particular boundary within a map. In one embodiment, each tile in FIG. 4 corresponds to an area of approximately 200 meters by 200 meters. Of course, the size of the tiles can vary and can be set by the system operator. The size of the tiles allows for the system to estimate the average occupancy of parking spaces within that particular tile, which is useful because parking spot occupancies can vary from place to place. For example, within a crowded urban environment, a certain area of a few blocks may be more difficult to find a parking space in than an area five or ten blocks away. Likewise, the average parking spot availability for a dense urban environment may be extremely smaller compared to a suburban area outside of the city, or a rural area far removed from the city.

FIG. 4 illustrates the concept of including several stacked layers for each tile. Each stacked layer can correspond to a given time period, for example one hour. This allows for the average parking occupancy to be determined not only based on geographic location (e.g., which tile the parking spaces are located in), but also temporally (e.g., during what time of day). In an embodiment in which each stacked layer corresponds to a given hour of the day, there would be 24 layers for each tile. On a 24-hour scale, each of these layers can therefore be referred to as a time-of-day window.

Moreover, the system can be configured to account for changes on a week-by-week basis. Average parking spot availability may be far less during the holiday season, for example. Therefore, each tile can have 168 layers, with each layer corresponding to a particular hour of the week. An average parking spot availability can thus be determined based on any given time period (e.g., hour) of a week. The number of layers per tile can vary and can be customized by the system operator. Each layer can be for a specific time of day (e.g., 24 layers per day), a week of the year (e.g., 52 layers per year) or a month of the year (e.g., 12 layers per year). Other time windows for each layer are contemplated.

It should be understood that the average parking spot availability can mean the average time a parking spot is available between moments in which it is unavailable. In other words, the average time between a particular parking space (a) changing from being occupied to unoccupied, and (b) changing back from unoccupied to occupied. In other embodiments, the average parking spot availability can mean the average amount of time the parking spaces within a given tile are available for a particular layer of time for that tile. For example, if there are 50 parking spaces within a particular tile or zone, the average parking spot availability would take into account the total amount of available time of all parking spaces within that zone for a given time layer, and divide by the number of parking spaces in that zone. In embodiments, the average parking spot availability can include a weighted average parking spot availability, wherein the latest availability status has more weight than previous availability statuses, and the weight can depend on the time difference of the availability status.

No matter the method of determination, the average parking spot availability can be determined for each time layer of each tile, as shown in FIG. 4. In this example, the average parking spot availability for the subject tile is 28.5 minutes during the hour of 11:00 pm to 12:00 am, while the average parking spot availability for the subject tile is 6.5 minutes during the hour of 10:00 am to 11:00 am.

It should be understood that the above examples describe determining average parking spot availability of the totality of the parking spaces within a particular tile or zone. This is in contrast to determine an average occupancy of an individual parking space at any time. Of course in other embodiments, such a determination can be made. For example, each tile can be resized the size of a parking spot, such that the average parking spot availability of each particular parking spot can be determined for any set time interval. However, this sort of system may be undesirable in certain circumstances due to the processing requirements and the potential for inaccuracies because the raw data monitoring the occupancy of any particular parking space may require a vehicle to pass by that parking space, moments of which can be distant in time.

Returning to FIG. 3, at 314 the system estimates a given parking spot's availability. This can be based on a determination that a parking spot is currently available, as detected by one or more vehicles passing by an unoccupied parking spot. The system then uses the average parking spot availability to estimate how long that particular spot will remain unoccupied. The estimated parking spot availability can be based on the average parking spot availability discussed above, e.g., for a given tile and time period. This provides a benefit of being able to estimate whether a particular parking spot is currently available even when live data is not available for that particular parking spot. For example, once a vehicle passes by a parking spot to allow the system to determine that the parking spot is available, there may not be another properly-equipped vehicle that passes by that parking space for quite some time in order to determine the live, real-time availability of that parking space. In lieu of real-time sensor data regarding the availability of the parking space, the system can rely on the average parking space availability to estimate whether that parking space is still available. For example, if the average parking space availability of a particular zone or tile and for a given time of day is 12 minutes, and one or more vehicles 110, 112 detects a particular parking space in that zone as being available, the system will determine that it is currently available and will estimate that it will remain available for the next 12 minutes. At the end of the 12 minutes, the system may no longer flag that parking space as available unless or until another vehicle 110, 112 subsequently detects it as available.

In determining estimating how long the parking spot is available, the system may rely on the last-known occupancy status of that parking spot. For example, if a parking spot is detected as being unoccupied at 3:16 pm, and the average parking spot availability is 12 minutes, then that particular parking spot will be estimated to be available until 3:28 pm, at which point the system will no longer estimate the parking spot as being available. However, at some time between 3:16 pm and 3:28 pm, for example at 3:20 pm, another vehicle may pass by the parking spot and detect the parking space is presently available. This is the new last-known occupancy status of that parking spot, and thus the system will estimate the parking spot will remain available until 3:32 pm.

In some embodiments, the system will estimate that the particular parking space is available only after a determination has been made that the particular parking space has transitioned from being unavailable to being available; only then will the system estimate the parking spot as being available for a threshold time period corresponding to the average parking spot availability in that tile and during that time. The system may estimate the parking spot is available for only the threshold period of time, regardless of whether other vehicles detect a vehicle as being within the parking spot or not. In embodiments, if one vehicle detects the parking spot is occupied even though the map shows (i.e., other vehicles have previously detected) the spot as being unoccupied, the vehicle will update the parking spot information and upload new information to the remote server, thereby changing the spot from being labeled as unoccupied to occupied. Regardless, after the threshold period of time, the system may estimate that the parking spot is no longer available, or its state is unknown or not determined until another sensor data indicates that the parking spot becomes occupied; then that spot is transitioned to an occupied status. This transition can be the trigger for the system to once again initiate the threshold period of time in which the parking spot will be estimated as available.

In embodiments, during the time period in which a parking spot is estimated as being available, the system may no longer estimate the parking spot is available if one or more vehicles detect that a vehicle has entered that parking space.

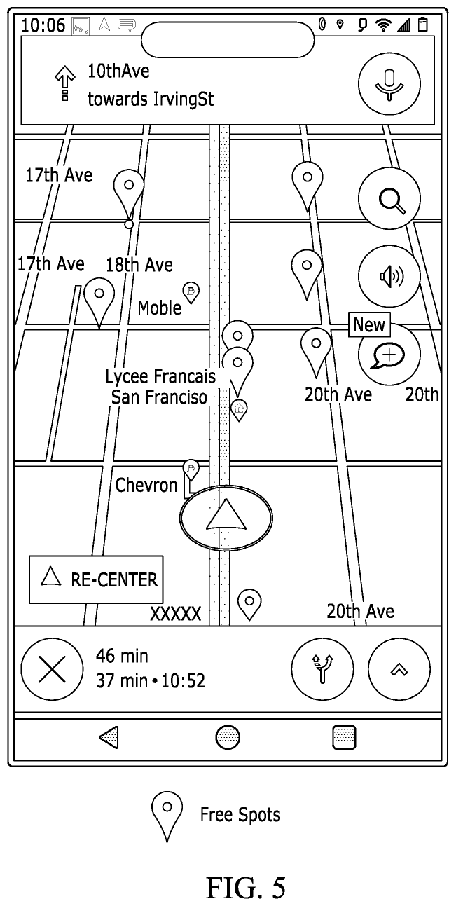

At 316, the system can integrate the parking spot availability information with map information for display on a display device. This allows a visualization of parking spaces that are either currently available or estimated to be available, as shown in FIG. 5. Meanwhile, currently-occupied parking spaces or parking spaces that are not estimated to be available (e.g., a time limit since the last sensor-based determination that the spot is occupied has exceeded the average parking spot available for that tile/time) will be hidden from view. In embodiments, mapping applications can integrate this parking space availability information. In such embodiments, the server 309 can communicate with one or more other servers that maintain or provide the mapping information necessary for navigation purposes, for example.

At 318, at least some of the data is transmitted to one or more of the vehicles 110, 112, e.g. ego vehicle 317. The transferred data can include the evaluation of parking spot occupancies over time 310, the average occupancies of parking spaces within the zone 312, and/or the data integrated with the map 316. The data sent at 318 should be sufficient data to allow the ego vehicle 317 to generate a display of currently-available parking spaces (based on real-time vehicle sensor data of other vehicles) and/or parking spaces that are estimated to be currently available.

At 320, a vehicle display associate with the ego vehicle 317 displays the parking spot availability. This can be in the form of data integrated into a map, as described above. The vehicle display can include an infotainment screen of the ego vehicle 317, a mobile device (e.g., smart phone) communicatively connected to the ego vehicle 317, a mobile device of a person riding in the ego vehicle 317, and the like. FIG. 5 illustrates an example user interface of a mobile device. Here, “free spots” indicate parking spots that are either currently available or are estimated to be available.

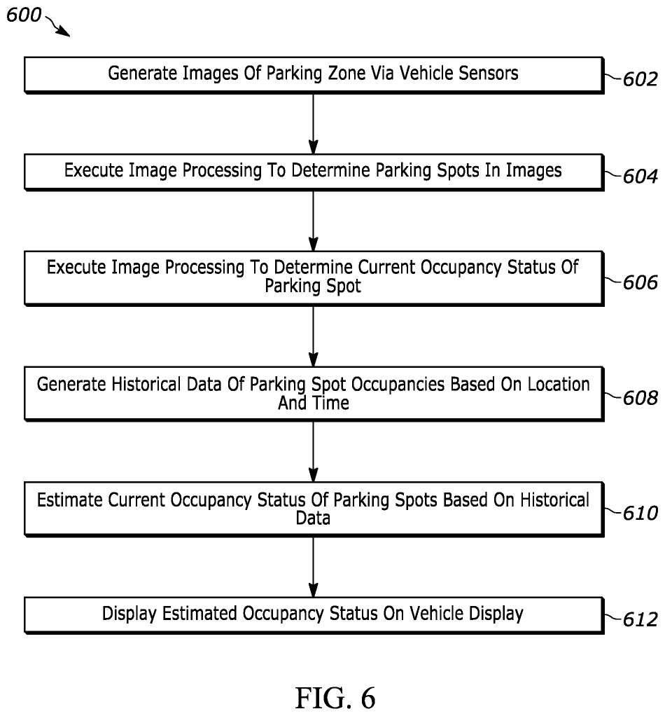

FIG. 6 illustrates a flow chart 600 of a method for assisting a driver in finding an available parking space by estimating the occupancy of parking spaces. The method may be performed by one or more of the computing systems 102 disclosed herein. At 602, one or more vehicle sensors 126 generate images of a parking zone. The parking zone can be parallel parking spaces adjacent to the traveled road, a parking lot, a parking garage, angled parking, and the like. At 604, a computing system 102 (e.g., onboard the vehicles) executes image processing to determine the presence of parking spots in the generated images. This step can also leverage map data or other prior data regarding the expected location and presence of parking spots as the vehicle travels.

At 606, the computing system (e.g., onboard the vehicles or at a remote server) executes image processing to determine the current occupancy status of a particular parking spot that was previously determined to exist. This may include utilizing an object detection model 136 to execute object recognition on the images to determine the presence of another vehicle as being located within the particular parking spot.

Steps 602-606 can be performed by multiple vehicles that are all in a common fleet, e.g., subscribed to a common application for estimating parking spot availability. At 608, the data collected by the vehicles is stored at the server as historical data. The historical data represents the parking spot occupancy status for parking spots. The data can be organized or categorized by tile and time, as described above. For example, historical parking spot occupancy data can be categorized or organized by particular region (e.g., 200 m by 200 m) and particular time period (e.g., by the hour). This allows the system to determine an average occupancy time of parking spaces for each particular region and each particular time period.

At 610, the system estimates a currently occupancy status of one or more parking spots based on the historical data. For example, the system can recognize, based on real-time sensor data, that a particular parking spot has transitioned from being occupied to being unoccupied. This particular parking spot can then be estimated to be available for the duration of the average occupancy time that corresponds to that particular region and that particular time period. At the conclusion of the average occupancy time, the parking spot will no longer be estimated to be available.

At 612, the parking spots that are estimated to be available are displayed on a vehicle display. For example, a navigation map can provide the locations of parking spaces that are currently estimated to be available.

The special information associated with the tiles may also affect the upload and download of the information to execute the system. For example, in areas where the tiles are located in dense urban environments, the exchange of data can be caused to occur at a greater rate than in areas where the tiles are located in rural areas.

In this disclosure, the terms “controller” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid- state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured, upon execution by the processor, to generate an estimated parking occupancy and display parking spaces that are estimated to be unoccupied, for example.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, e.g., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”). Such a special purpose circuit may be referred to as a computer processor even if it is not a general-purpose processor.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for estimating parking spot availability, the system comprising:
a plurality of image sensors mounted to a plurality of vehicles and configured to generate images associated with an environment about the plurality of vehicles; and
one or more processors in communication with the plurality of image sensors and programmed to:
execute image processing to determine a presence of parking spots in the images and whether other vehicles are located in the parking spots;
determine an occupancy status of each parking spot over time based upon the image processing;
store the occupancy status of each parking spot in storage to yield a historical occupancy status;
define a first set of the parking spots as being located within a first common geographical region;
determine an average parking spot availability of the first set of parking spots based on the historical occupancy status associated with the first set of parking spots;
generate an estimated occupancy status of a first parking spot of the first set of parking spots, wherein the estimated occupancy status is based on a last-known occupancy status of the first parking spot and the average parking spot availability associated with the first set of parking spots; and
display the estimated occupancy status of the first parking spot on a display device associated with a first vehicle of the plurality of vehicles.

2. The system of claim 1, wherein the one or more processors is further programmed to:
define a second set of the parking spots as being located within a second common geographical region; and
determine a weighted average parking spot availability of the second set of parking spots based on the historical occupancy status associated with the second set of parking spots;
wherein the weighted average parking spot availability of the second set of parking spots is different than the average parking spot availability of the first set of parking spots.

3. The system of claim 1, wherein the one or more processors is further programmed to determine a plurality of average parking spot availabilities of the first set of parking spots for a corresponding plurality of time windows, each time window having a different average parking spot availability.

4. The system of claim 3, wherein the plurality of time windows includes a first time window, and wherein the estimated occupancy status is based upon the average parking spot availability corresponding to the first time window.

5. The system of claim 4, wherein the first time window corresponds with a current time in which the estimated occupancy status is displayed on the display device.

6. The system of claim 3, wherein each time window corresponds to a time of day, a week of the year, or a month of the year.

7. The system of claim 1, wherein the estimated occupancy status of the first parking spot is displayed on the display device along with a location of the first parking spot relative to a current location of the first vehicle.

8. A method of assisting a driver in finding an available parking spot by estimating parking spot availability, the method comprising:
generating, via a plurality of image sensors mounted to a plurality of vehicles, images associated with an environment surrounding the plurality of vehicles;
executing image processing to determine a presence of parking spots in the images and whether other vehicles are located in the parking spots;
determining an occupancy status of each parking spot over time based upon the image processing;
storing the occupancy status of each parking spot in storage to yield a historical occupancy status associated with the parking spots;
defining a first set of the parking spots as being located within a first common geographical region;
determining an average parking spot availability of the first set of parking spots based on the historical occupancy status associated with the first set of parking spots;
generating an estimated occupancy status of a first parking spot of the first set of parking spots based upon the average parking spot availability associated with the first set of parking spots; and
displaying the estimated occupancy status of the first parking spot on a display device associated with a first vehicle of the plurality of vehicles.

9. The method of claim 8, wherein the estimated occupancy status is generated based additionally on a last-known occupancy status of the first parking spot.

10. The method of claim 8, further comprising:
defining a second set of the parking spots as being located within a second common geographical region; and
determining a weighted average parking spot availability of the second set of parking spots based on the historical occupancy status associated with the second set of parking spots;
wherein the weighted average parking spot availability of the second set of parking spots is different than the average parking spot availability of the first set of parking spots.

11. The method of claim 8, further comprising:
determining a plurality of average parking spot availabilities of the first set of parking spots for a corresponding plurality of time windows, each time window having a different average parking spot availability.

12. The method of claim 11, wherein the plurality of time windows includes a first time window, and wherein the estimated occupancy status is based upon the average parking spot availability corresponding to the first time window.

13. The method of claim 12, wherein the first time window corresponds with a current time in which the estimated occupancy status is displayed on the display device.

14. The method of claim 11, wherein each time window corresponds to a time of day, a week of the year, or a month of the year.

15. The method of claim 8, wherein the estimated occupancy status of the first parking spot is displayed on the display device along with a location of the first parking spot relative to a current location of the first vehicle.

16. A non-transitory data storage medium comprising programming instructions that when executed by a processor cause the processor to:
generate, via a plurality of image sensors mounted to a plurality of vehicles, images associated with an environment surrounding the plurality of vehicles;
execute image processing to determine a presence of parking spots in the images and whether other vehicles are located in the parking spots;
determine an occupancy status of each parking spot over time based upon the image processing;
store the occupancy status of each parking spot in storage to yield a historical occupancy status associated with the parking spots;
define a first set of the parking spots as being located within a first common geographical region;
determine an average parking spot availability of the first set of parking spots based on the historical occupancy status associated with the first set of parking spots;
generate an estimated occupancy status of a first parking spot of the first set of parking spots based upon the average parking spot availability associated with the first set of parking spots; and
display the estimated occupancy status of the first parking spot on a display device associated with a first vehicle of the plurality of vehicles.

17. The non-transitory data storage medium of claim 16, wherein the estimated occupancy status is generated based additionally on a last-known occupancy status of the first parking spot.

18. The non-transitory data storage medium of claim 16, further comprising programming instructions that when executed by the processor cause the processor to:
define a second set of the parking spots as being located within a second common geographical region; and
determine an average parking spot availability of the second set of parking spots based on the historical occupancy status associated with the second set of parking spots;
wherein the average parking spot availability of the second set of parking spots is different from the average parking spot availability of the first set of parking spots.

19. The non-transitory data storage medium of claim 16, further comprising programming instructions that when executed by the processor cause the processor to:
determine a plurality of average parking spot availabilities of the first set of parking spots for a corresponding plurality of time windows, each time window having a different average parking spot availability.

20. The non-transitory data storage medium of claim 19, wherein the plurality of time windows includes a first time window, and wherein the estimated occupancy status is based upon the average parking spot availability corresponding to the first time window.
